(19) United States
(12) Patent Application Publication
(10) Pub. No.: US 2012/0154596 A1
(43) Pub. Date: Jun. 21, 2012

(54) REDUCING NOISE IN A COLOR IMAGE

(76) Inventor: Andrew Augustine Wajs, Haarlem (NL)

(21) Appl. No.: 13/392,101

(22) PCT Filed: Aug. 25, 2009
(86) PCT No.: PCT/EP2009/060936

§ 371 Date: Feb. 24, 2012

(51) Int. Cl. H04N 5/33

(52) U.S. Cl. 348/164; 348/E05.09

(57) ABSTRACT

A method and an imaging system is described for providing a low noise color image. The method comprises the steps of: exposing an image sensor to visible spectral energy and non-visible spectral energy, said image sensor comprising pixels for obtaining first image data associated with said visible spectral energy and pixels for obtaining second image data associated with said non-visible spectral energy; generating first and second image data; subjecting said first image data to a low-pass filt and said second image data to a high-pass filter; and, forming a color image by adding at least part of the high frequency components of said second image data to at least part of the low frequency components of said first image data.

### FIELD OF THE INVENTION

The invention relates to reducing noise in a color image, and, in particular, though not exclusively, to a method and a system for providing a low-noise color image, an image processing apparatus and an image sensor for use in such system and a computer program product using such method.

### BACKGROUND OF THE INVENTION

Conventional digital cameras use filters, e.g. a color filter array (CFA) interposed between the lens and the image sensor and an infrared blocking filter before the lens in order to reproduce a color image which matches the real scene as much as possible. The use of filters however reduces the amount of light reaching the image sensor thereby substantially degrading the signal-to-noise ratio (SNR) of the camera. Moreover, current trends in digital camera technology such as increasing the sensor resolution by reducing the pixel size and the desire to obtain improved image quality at higher ISO sensitivities for capturing images in low light conditions, may result in further degradation of the SNR.

Measures for increasing the SNR such as exposing the image sensor to more light using longer exposure times or a larger aperture may lead to motion blur and/or reduced depth of field (DOF) and thus do not provide a real improvement. A further option would be to increase the ISO speed (i.e. increasing the gain of the image sensor). Increasing the ISO speed however significantly increases the image noise. Hence, techniques to reduce noise become increasingly important in order to improve or at least maintain the SNR at a desired level at low light conditions and/or when using image sensors with reduced pixel size.

One way of improving the SNR of a digital camera may be the use of an image sensor with extended spectral sensitivity. For example US2007/0153335 describes the use of an image sensor comprising RGB pixels and non-filtered (transparent) pixels. The signals of the transparent pixels are used in a noise reduction scheme, wherein the relatively high-noise RGB pixel signals are filtered on the basis of edge information comprised in the transparent pixel signal. The noise reduction scheme however is rather complex and relies on edge-preserving filtering. The problem related to the use of an edge-preserving filter (e.g. a median filter, a bilateral filter, etc.) is that for details that are not associated with a hard or clear edge, such filter ultimately is unable to determine the difference between noise and actual image detail.

Hence, there is a need in the art for methods and systems for providing a simple and efficient way of providing a color image with an improved SNR.

### SUMMARY OF THE INVENTION

It is an object of the invention to reduce or eliminate at least one of the drawbacks known in the prior art. In a first aspect the invention may related to a method of processing a color image.

The method may comprise the steps of: exposing an image sensor to visible spectral energy and non-visible spectral energy, said image sensor comprising pixels for obtaining first image data associated with said visible spectral energy and pixels for obtaining second image data associated with said non-visible spectral energy; generating first and second image data; subjecting said first image data to a low-pass filter and said second image data to a high-pass filter; and, forming a color image by adding at least part of the high frequency components of said second image data to at least part of the low frequency components of said first image data.

Various image sensors for generating first image data associated with visible spectral energy and second image data associated with non-visible spectral energy may be used. In one embodiment, said pixels for obtaining said first image data may comprise one or more color pixel filters configured for transmitting at least part of said visible spectral energy. In another embodiment said pixels for obtaining said second image data may comprise one or more infrared transmissive pixels filters configured for transmitting a substantial part of said non-visible spectral energy and blocking a substantial part of said visible spectral energy. In yet another embodiment, said pixels for obtaining first and second image data comprise two or more vertically stacked photo-sensors, at least one of said photo-sensors being response to a predetermined part of said visible spectral energy and said at least one of said photo-sensor being responsive to a predetermined part of said non-visible spectrum.

Hence, in contrast with known noise reduction schemes, the noise reduction process according to the invention produces a “composite” low-noise color image wherein the color information is provided by the low frequency components of the RGB image data produced by the RGB pixels and wherein the image detail information is provided by the high frequency components of the infrared image data produced by the infrared pixels. The color image may be obtained by simply adding the low-frequency RGB image data to the high-frequency infrared image data. The invention relies on the fact that the image sensor will produce a relatively low-noise infrared pixel signal enabling effective noise suppression in a color image and substantially improving the SNR of the color image.

In one embodiment, the image sensor may be exposed to said visible spectral energy using at least a first aperture and to said non-visible spectral energy using at least a second aperture. In another embodiment, said first aperture may be adapted to control exposure of the image sensor to at least part of said non-visible spectral energy and wherein said second aperture may be adapted to control exposure of said image sensor to at least part of said visible spectral energy. In a further embodiment, the method further comprises the step of amplifying the filtered high-frequency components of said second image data in proportion to the ratio of the first aperture relative to the second aperture. The use of a dual aperture provides an imaging system with a fixed focus lens (e.g. a camera in a mobile phone) to have a wide aperture, hence operate effectively in lower light situations, while at the same time to have a greater DOF and SNR resulting in sharper pictures.

In one variant the method may further comprise the step of amplifying one or more image sensor signals associated with said visible spectral energy according to at least a first ISO speed and amplifying one or more image sensor signals associated with said non-visible spectral energy according to at least a second ISO speed, wherein said first ISO speed is larger than said second ISO speed. In one embodiment the ratio between said first and second ISO value may be set approximately between 2 and 8. By using dual ISO settings improved color images may be obtained in low-light conditions.

In another variant, the method may further comprise the steps of setting the exposure time for exposing one or more pixels associated with said non-visible spectral energy to a lower value than the exposure time for exposing one or more pixels associated with said visible spectral energy. Using a relatively short exposure time for the infrared pixels may result in a color image with reduced blur.

In a further variant the method may further comprise the step of subtracting at least part of said second image data from at least part of said first data in order to form corrected color image data. Hence, the infrared image data may be used for efficiently eliminating the infrared component in the signals produced by the color pixels.

In yet another embodiment the method may further comprise the steps of: providing mosaic image data generated by said image sensor, generating on the basis of said image data at least one or more first color image data associated one or more color pixels and second image data associated with said infrared pixels using a demosaicing algorithm.

In a further aspect, the invention may relate to an image processing apparatus comprising: an input for receiving image data generated by exposing an image sensor to visible and non-visible spectral energy, said image data comprising first image data associated with visible spectral energy and second image data associated with non-visible spectral energy; a noise reduction unit configured to subject said first image data to a low-pass filter and said second image data to a high-pass filter; and, a blending unit for adding said high-pass filtered infrared image data to said low-pass filtered color image data.

In one embodiment, the apparatus may further comprise a demosaic processing unit for receiving mosaic image data generated by an image sensor, said mosaic data comprising first mosaic image data associated with one or more color pixel filters and second mosaic image data associated with one or more infrared pixel filters;

In another embodiment the processing apparatus may further comprise: a color correction unit being configured to receive input from said demosaic processing unit, said color correction unit being configured to subtract second demosaiced image data associated with one or more infrared pixel filters from said first demosaiced image data associated with one or more color pixel filters.

In another aspect the invention may relate to an imaging system comprising: an image sensor configured for exposure to visible spectral energy and non-visible spectral energy, said image sensor comprising pixels for obtaining first image data associated with said visible spectral energy and pixels for obtaining second image data associated with said non-visible spectral energy; an aperture system adapted to control exposure of the image sensor to the visible and non-visible spectral energy, and, an image processing apparatus as described above.

In one embodiment said aperture system comprises at least a first aperture adapted to control exposure of the image sensor to at least part of said non-visible spectral energy and at least a second aperture adapted to control exposure of said image sensor to at least part of said visible spectral energy.

The invention further relates to an image sensor for use in an imaging system according as described above, wherein the sensor comprises: a pixel array, preferably a two-dimensional pixel array, defining one or more color pixels sensitive to visible spectral energy and one or more infrared pixels sensitive to non-visible spectral energy; and, at least one first amplifier associated with at least a part of said color pixels for setting ISO speed associated with said color pixels to a first ISO speed value and a second amplifier associated with at least a part of said infrared pixels for setting the ISO speed associated with said infrared pixels to a second ISO speed value, said first ISO speed value being larger than said second ISO speed value, preferably said first and second amplifier being configured such that the ratio between said first and second ISO speed value may be controlled approximately between 2 and 8.

In a further embodiment, the image sensor may further comprise a first electronic shutter associated with at least a part of said color pixels for setting the exposure time associated with said color pixels to a first exposure value and a second electronic shutter associated with at least a part of said infrared pixels for setting the exposure time associated with said infrared pixels to a second exposure time value. Hence, in this embodiment the image sensor is especially adapted for use with the image processing apparatus for effectively reducing the noise in a color image using the high-frequency components of the infrared signal generated by the infrared pixels. Further, the image sensor may independently set signal gain (ISO speed) and the exposure time for the color pixels and the infrared pixels so that the imaging system may use a dual ISO and/or a dual exposure mode for increasing SNR under low-light conditions and/or reducing motion blur.

The invention may also relate to a computer program product for processing a color image, wherein said computer program product comprising software code portions configured for, when run in the memory of a computer system, executing the method steps as described above; to a data signal embodied in a carrier wave propagating over a transmission line of a computer system and/or a data network connected to a computer system, wherein said data signal comprises data encoding at least part of a computer program product as described above; and to a computer program storage medium readable by a computer system and encoding a computer program product for managing secure access to one or more resources of a computer system as described above.

The invention will be further illustrated with reference to the attached drawings, which schematically will show embodiments according to the invention. It will be understood that the invention is not in any way restricted to these specific embodiments.

### BRIEF DESCRIPTION OF THE DRAWINGS

FIG. 1 depicts an imaging system according to one embodiment of the invention.

FIG. 2 depicts a typical color response of a digital camera without an infrared blocking filter.

FIG. 3 depicts the photo-response of Silicon and an infrared blocking filter.

FIG. 4 depicts a schematic of (A) an infrared/color filter array and (B) a stacked photodiode structure.

FIG. 5 depicts a flow diagram of a noise reduction scheme according to one embodiment of the invention.

FIG. 6 depicts a dual aperture for use in an imaging system according to one embodiment of the invention.

FIG. 7 depicts the principle of improving the DOF in an imaging system using a double aperture.

### DETAILED DESCRIPTION

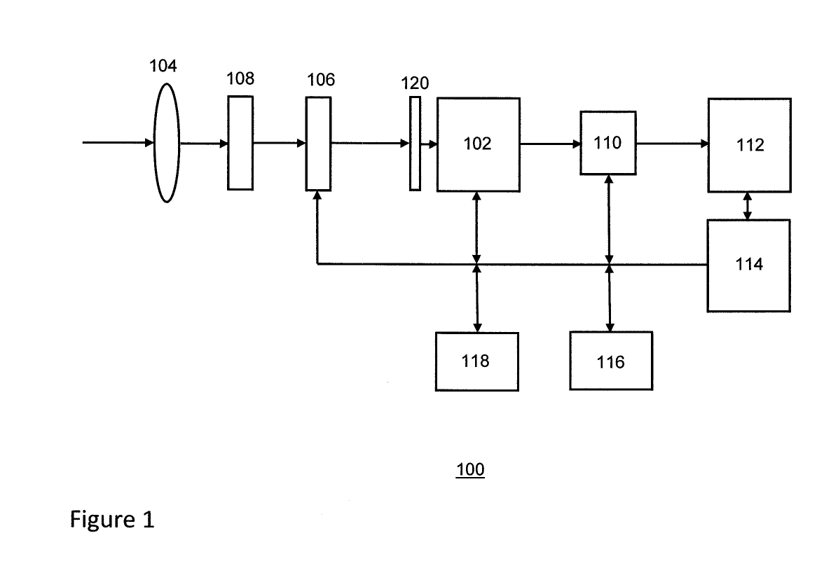

FIG. 1 illustrates an imaging system 100 according to one embodiment of the invention. The imaging system comprises an image sensor 102, a lens system 104 for focusing objects in a scene onto the imaging plane of the image sensor, a shutter 106 and an aperture system 108 comprising at least one aperture for allowing light (electromagnetic radiation) of the visible part (e.g. RGB) and the non-visible part (e.g. infrared) of the electromagnetic spectrum to enter the imaging system. The imaging system may be part of a digital camera or integrated in a mobile phone, a webcam and another multimedia device requiring image-capturing functionality.

The exposure of the image sensor to light is controlled by a shutter and the aperture. When the shutter is opened, the aperture controls the amount of light and the degree of collimation of the light exposing the image sensor. The shutter may be a mechanical shutter or, alternatively, the shutter may be an electronic shutter integrated in the image sensor. The image sensor comprises rows and columns of photosensitive sites (pixels) forming a two dimensional pixel array. The image sensor may be a CMOS (Complimentary Metal Oxide Semiconductor) active pixel sensor or a CCD (Charge Coupled Device) image sensor.

When the light is projected by the lens system onto the image sensor, each pixel produces an electrical signal, which is proportional to the electromagnetic radiation (energy) incident on that pixel. In order to obtain color information and to separate the color components of an image which is projected onto the imaging plane of the image sensor, typically a color filter array 120 (CFA) is interposed between the lens and the image sensor. The color filter array may be integrated with the image sensor such that each pixel of the image sensor has a corresponding pixel filter. Each color filter is adapted to pass light of a predetermined color band into the pixel. Usually a combination of red, green and blue (RGB) filters is used, however other filter schemes are also possible, e.g. CYGM (cyan, yellow, green, magenta), RGBE (red, green, blue, emerald), etc.

Each pixel of the exposed image sensor produces an electrical signal proportional to the electromagnetic radiation passed through the color filter associated with the pixel. The array of pixels thus generates image data (a frame) representing the spatial distribution of the electromagnetic energy (radiation) passed through the color filter array. The signals received from the pixels may be amplified using one or more on-chip amplifiers. In one embodiment, each color channel of the image sensor may be amplified using a separate amplifier, thereby allowing to separately control the ISO speed for different colors.

Further, pixel signals may be sampled, quantized and transformed into words of a digital format using one or more Analog to Digital (A/D) converters 110, which may be integrated on the chip of the image sensor. The digitized image data are processed by a digital signal processor 112 (DSP) coupled to the image sensor, which is configured to perform signal processing functions such as interpolation, filtering, white balance, brightness correction, data compression techniques (e.g. MPEG or JPEG type techniques), etc. The DSP is coupled to a central processor 114, storage memory 116 for storing captured images and a program memory 118 such as EEPROM or another type of nonvolatile memory comprising one or more software programs used by the DSP for processing the image data or used by a central processor for managing the operation of the imaging system.

In order to increase the sensitivity of the imaging system, the lens system is configured to allow both visible light and infrared radiation or at least part of the infrared radiation to enter the imaging system. To that end, the imaging system does not comprise a filter in front of lens system, which blocks all infrared radiation from entering. The electromagnetic radiation 122 entering the imaging system via the lens system may thus comprise both radiation associated with the visible and the infrared parts of the optical spectrum thereby extending the photo-response of the image sensor to the infrared.

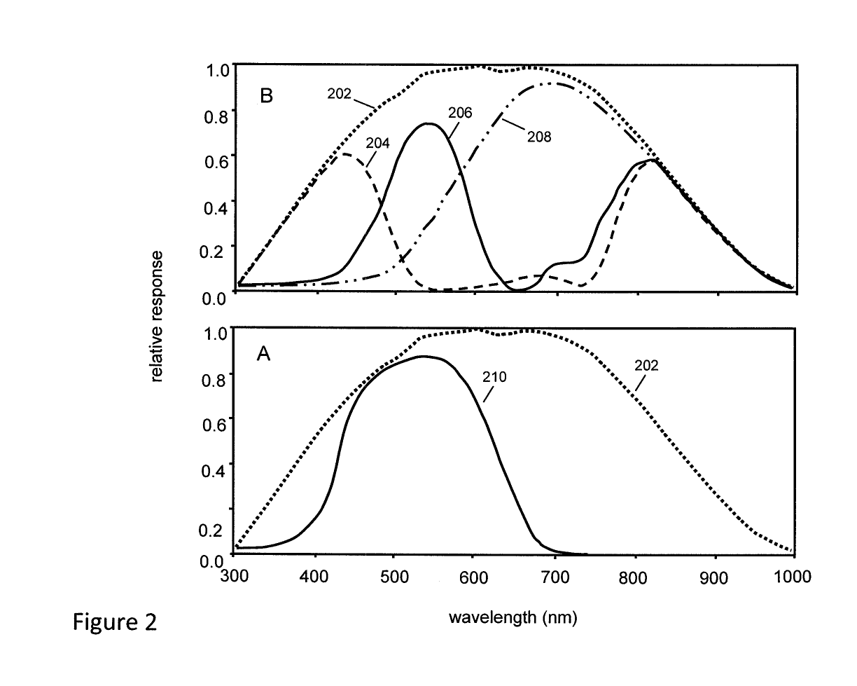

The effect of (the absence of) an infrared blocking filter on a conventional CFA color image sensor is illustrated in FIG. 2. Curve 202 in graphs A and B represents a typical color response of a digital camera without an infrared blocking filter (hot mirror filter). Graph A illustrates the effect of the use of a hot mirror filter. The response of the hot mirror filter 210 limits the spectral response of the image sensor to the visible spectrum thereby substantially limiting the overall sensitivity of the image sensor. If the hot mirror filter is taken away, some of the infrared radiation will pass through the color pixel filters. This effect is depicted by graph B illustrating the photo-responses of the color pixels comprising a blue pixel filter 204, a green pixel filter 206 and a red pixel filter 208. The color pixel filters, in particular the red pixel filter, (partly) transmit infrared radiation so that a part of the pixel signal may be attributed to infrared radiation. These infrared contributions may distort the color balance resulting into an image comprising so-called false colors.

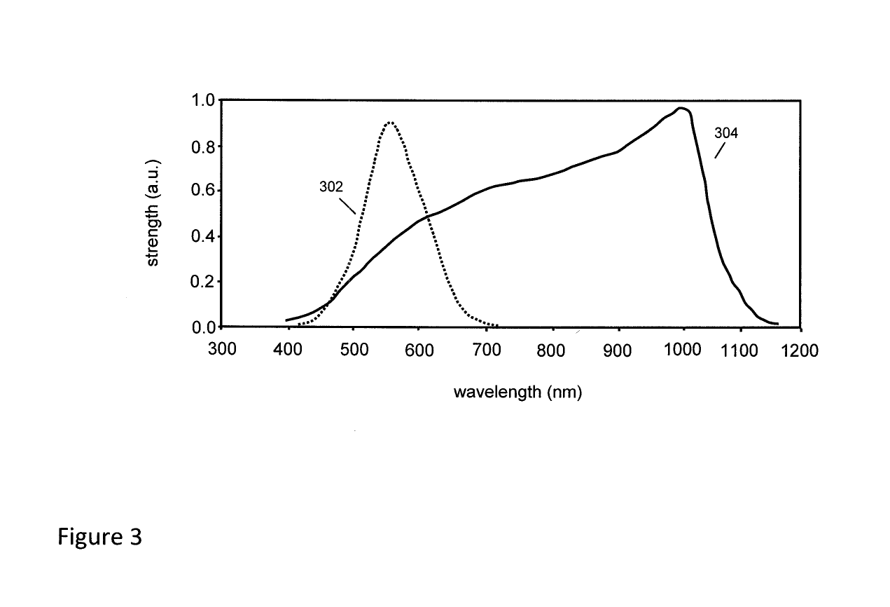

FIG. 3 depicts a graph comprising the response of the hot mirror filter 302 and the response of Silicon 304, i.e. the main semiconductor component of an image sensor used in digital cameras. This graph clearly illustrates that the sensitivity of a Silicon image sensor to infrared radiation is approximately four times higher than its sensitivity to visible light.

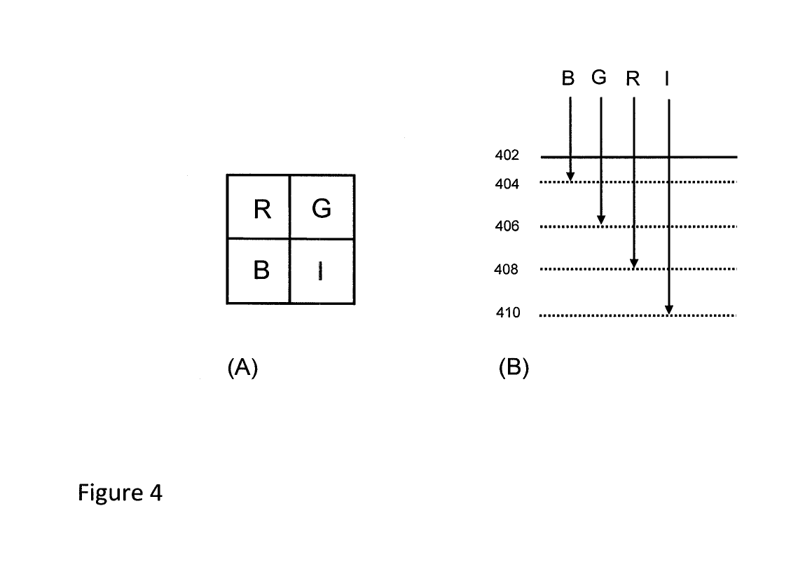

Hence, in order to take advantage of the spectral sensitivity provided by the image sensor, the image sensor 102 in the imaging system in FIG. 1 comprises one or more pixels for retrieving a pixel signal associated with the infrared spectral energy thereby allowing an imaging system to produce a RGB color image and a relatively low noise infrared image. Examples of such image sensors are depicted in FIG. 4. FIG. 4 (A) depicts an embodiment wherein the image sensor comprises one or more infrared (I) pixels in conjunction with color pixels. Such infrared pixel may be realized by covering a photo-site with a filter material which substantially blocks visible light and substantially transmits infrared radiation, preferably infrared radiation within the range of approximately 700 through 1100 nm. The infrared transmissive pixel filter in such infrared/color filter array (ICFA) may be realized using well known filter materials having a high transmittance for wavelengths in the infrared band of the spectrum, for example a black polyimide material sold by Brewer Science under the trademark “DARC 400”. Methods to realized such filters are described in US2009/0159799. An ICFA may contain blocks of pixels, e.g. 2×2 pixels, wherein each block comprises a red, green, blue and infrared pixel. When being exposed, such image ICFA color image sensor may produce a raw mosaic image comprising RGB color information and infrared information. After processing the raw mosaic image using a well-known demosaicking algorithm, a RGB color image and an infrared image may obtained. The sensitivity of such ICFA image color sensor to infrared radiation may be increased by increasing the number of infrared pixels in a block. In one configuration(not shown), the image sensor filter array may for example comprise blocks of sixteen pixels, comprising four color pixels RGGB and twelve infrared pixels.

In yet another embodiment, the image sensor may comprise an array of photo-sites wherein each photo-site comprises a number of stacked photodiodes. Preferably, the stacked photo-site comprises at least four stacked photodiodes responsive to at least the primary colors RGB and infrared respectively. These stacked photodiodes may be integrated into the Silicon substrate of the image sensor. FIG. 4(B) depicts a schematic of such stacked photo-site. The photodiodes 404,406,408,410 are located at different depths in the Silicon substrate of the image sensor so that each of the photodiodes is responsive to a different part of the spectrum. The longer the wavelength, the deeper the light will penetrate into the Silicon. The photodiode 404 closest to the light-receiving surface 402 of the image sensor will thus have a spectral response in the blue thereby forming a blue (color) pixel, while the photodiode 410 furthest removed from the surface 402 will have a spectral response in the infrared thus forming an infrared (I) pixel. Such RGBI image sensor comprising vertically stacked photodiodes provides the advantage that the signals of the color pixels allow direct formation of a RGB color image and an infrared image without the need of demosaicking.

The image sensors may comprise one or more amplifiers for amplifying the pixels signals of the color and infrared and/or transparent pixels and one or more electronic shutters for exposing the pixels for a predetermined exposure time. Typically, the amplifier and shutter electronics may be integrated on the image sensor chip. In one embodiment, the color pixels may have an amplifier and/or an electronic shutter for setting the ISO speed and/or exposure time associated with the color pixels. Similarly, the infrared pixels may have an amplifier and/or an electronic shutter for setting the ISO speed and/or exposure time associated with the infrared pixels.

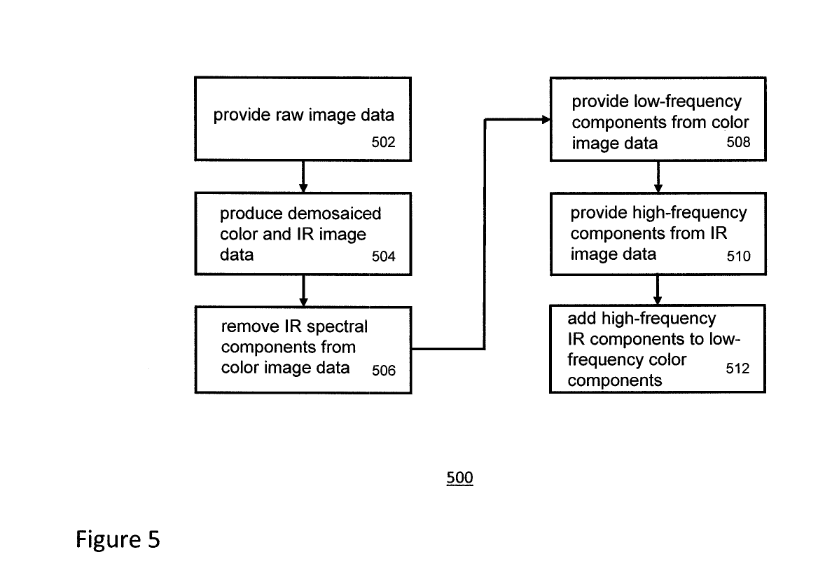

The infrared image data generated by the infrared pixels of the image sensor as depicted in FIG. 4 may be used to produce a color image with improved SNR characteristics. One embodiment of such process is depicted in more detail in FIG. 5. In this embodiment an imaging system comprising an IFCA color image sensor is used. In the first step of the process the image sensor produces raw image data comprising a mosaic representing the distribution of photon energies in the color (RGB) and infrared spectrum incident to the photo-receiving area of the image sensor (step 502). The mosaic image data are subsequently demosaicked in three (R′G′B′) color images and an infrared image using a well-known demosaicking algorithm (step 504). The R′G′B′ color image may still contain the undesired infrared information, which may be removed by subtracting the infrared image from the color images thereby producing compensated (true) RGB color images (step 506). Alternatively, the R′G′B′ color image may be corrected using a well known white balancing technique. Thereafter, the RGB color images are subjected to a low-pass filter, such as a finite input response filter or an edge-preserving filter, thereby effectively producing a blurred or at least a partly blurred image wherein the contrast information and high frequency noise is suppressed (step 508). The infrared image data are subjected to a high-pass filter in order to extract the high-frequency components of the infrared image pixel signals, comprising the contrast information of the infrared image (step 510). In one embodiment (not shown), the infrared image may be further subjected to an edge preserving filtering step. Such edge-preserving filtering step may further enhance the contrast information in the infrared image data. The high-pass filtered infrared image data and the low-pass filtered color image data are subsequently added (blended) in order to form a full color RGB image (step 512). Hence, in contrast with known noise reduction schemes, the noise reduction process according to the invention produces a “composite” low-noise color image wherein the color information is provided by the low frequency components of the RGB image data produced by the RGB pixels and wherein the image detail information is provided by the high frequency components of the infrared image data produced by the infrared pixels. The color image may be obtained by simply adding the low-frequency RGB image data to the high-frequency infrared image data. The invention relies on the fact that the image sensor will produce a relatively low-noise infrared pixel signal. The method allows effective noise suppression in a color image and may substantially improve the SNR of the color image. In one variant, the RBG color image may be further transformed to a suitable color space, for example an LAB color space, which is based on the CIE 1931 XYZ color space defined by the Commission International de l' éclairage and designed to approximate human vision. Thereafter, the high frequency infrared components are added to the L (lightness contrast) component of the LAB color image.

The method may be implemented as a noise suppression function in the DSP of the imaging system. Typically, the method will be implemented as a software program or as a combination of hardware circuitry and a software program.

Although the method depicted in FIG. 5 is described using an ICFA-type image sensor for obtaining the infrared image data, the invention may also be used with other image sensors. In one embodiment, the method depicted in FIG. 5 may also be used with a RGBI image sensor comprising vertically stacked photodiodes as described with reference to FIG. 4(B). Using such image sensor provides the advantages that a demosaicking step 504 and the color compensation step 506 as described with reference to FIG. 5 are not required.

In a further embodiment (not shown), a color image sensor comprising one or more panchromatic or transparent pixels may be used. Such color image sensors are for example known from US2007/0153335, US2007/0145273 or WO2007/015982 and comprise (blocks of) RGB pixels and one or more transparent (T) or panchromatic pixels which are sensitive to both the visible and the non-visible (infrared) spectrum. After capturing raw image data using such image sensor, the color balance of the captured RGB data may first be restored using a known white balancing technique as disclosed for example in US2007/0153335. Thereafter, the RGB image data are filtered using a low pass filter and the image data associated with the transparent pixels (comprising both a RGB part and an infrared part) are filtered using a high-pass filter. The high frequency components of the transparent pixel signals are subsequently added to the low pass filtered RGB image data in order to form a color image having an improved SNR.

The noise reduction method may allow further improvement of the image quality under low (visible) light conditions. For that purpose, in a further embodiment, the color pixels of the image sensor may be set to a high ISO speed (e.g. as defined by ISO standard 12232:2006), e.g. between 3200 and 6400, in order to provide a high-noise color image under low light conditions. Setting the color pixels to a higher ISO rating effectively means that the signal gain of amplifier associated with the color pixels is increased.

The infrared pixels of the image sensor may be set to a low ISO speed, e.g. between 400 and 1600 for producing a low-noise infrared image. In one embodiment, the ratio between the high and low ISO value may set between 2 and 8. Subsequent processing of the raw image data captured under low light conditions by the image sensor in the dual ISO mode using the method as described with reference to FIG. 5, will result in a color image with improved SNR. The method allows optimal use of the intrinsic infrared sensitivity of the image sensor and does not require complex processing.

In a further embodiment, the method in FIG. 5 may be used for reducing the effect of camera shake, in particular when using relatively long exposure times. In that case the sensitive infrared pixels may be set to the same sensitivity (the same ISO speed) as the color pixels. The exposure time for the infrared pixels however may be significantly reduced with respect to the exposure time of the color pixels. For example, if the exposure time for the color pixels is set to ¼ second, the exposure time for the infrared pixels is set to 1/60 of a second thereby providing a high-contrast infrared image. Subsequent processing of the raw image data produced by the image sensor using the method depicted in FIG. 5 will result in a color image with reduced blur.

The exposure times for the color pixels and the infrared pixels may be controlled by using a first electronic shutter for the color pixels and a second electronic shutter for the infrared pixels. Alternatively, the color image and the infrared image may be obtained by capturing two subsequent images in time, a first image associated with a relatively long exposure time and a second image associated with a relatively short exposure time.

Hence, using the noise reduction method in combination with an image sensor configured to independently control the signal gain (ISO speed) and the exposure time of the color pixels and the infrared pixels respectively, allows the imaging system to use a dual ISO and/or a dual exposure mode for increasing SNR under low-light conditions and/or for reducing motion blur.

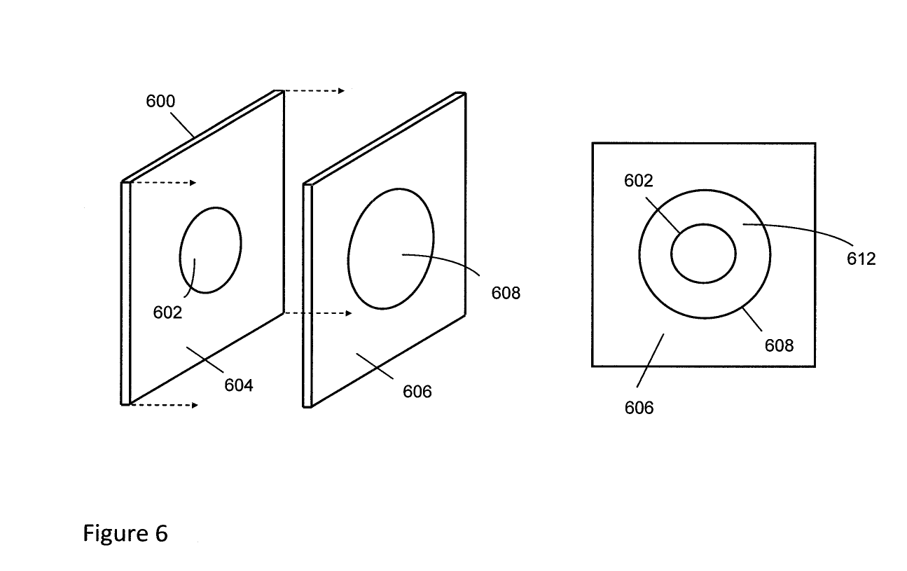

In yet a further embodiment, the noise reduction method may be used in an imaging system comprising a dual-aperture. Such dual-aperture may be used for improving the depth of field (DOF) of a camera. The DOF determines the range of distances from the camera that are in focus when the image is captured. The wider the aperture (the more light received) the more limited the DOF. One embodiment of such dual aperture is schematically depicted in FIG. 6. The dual aperture system 600 comprises a substrate 602 with an opening 604 (e.g. a circular hole) in the middle. The substrate material may be transparent to at least visible radiation and may be coated by a thin film filter material 606 such as a dielectric filter. In one embodiment the substrate is coated with a dichroic filter which reflects radiation in the infra-red spectrum and transmits radiation in the visible spectrum. Dichroic filters also referred to as interference filters are well known in the art and typically comprise a number of thin-film dielectric layers of specific thicknesses which are configured to reflect infra-red radiation (e.g. radiation having a wavelength between approximately 750 to 1250 nanometers) and to transmit radiation in the visible part of the spectrum.

The substrate may be positioned before the lens in the imaging system using a holder 604 of an opaque material. The holder comprises a circular opening 608 and is configured to receive and position the substrate such that the opening in the substrate is located in the center of the circular opening of the holder. As the diameter of the holder opening is large than the diameter of the substrate opening, part of the filter coated substrate is exposed by radiation entering the imaging system via the lens. The exposed part forms a concentric ring 610 around the substrate hole.

The multi-aperture may be formed by using several separate aperture elements, e.g. a first transparent substrate comprising a first circular filter coating in optical alignment with a second transparent substrate comprising a second circular filter and the one or more lenses of the optical system thereby effectively providing the same effect as the dual aperture system as described in relation with FIG. 6. Alternatively, the aperture system may be integrated with lens by using the lens as a substrate for the first and second filter coatings forming the aperture system.

In a variant, the dual aperture system may be formed by two or more lens systems, e.g. a first lens system with associated first aperture system and a second lens system with associated second aperture system.

Visible and the non-visible (infrared) spectral energy enter the imaging system via the dual aperture system. As the infrared blocking filter used in the aperture system is transparent for visible light, the amount of radiation in the visible spectrum entering the imaging system is controlled by the diameter of the holder opening. On the other hand, as the filter blocks all or at east a substantial part of the infrared radiation, the amount of radiation in the infrared spectrum entering the imaging system is controlled by the diameter of the opening in the substrate, which is smaller than the diameter of the holder opening.

Hence, contrary to imaging systems comprising a single aperture, a dual aperture imaging system uses an aperture system comprising two (or more) apertures of different sizes for controlling the amount and the collimation of radiation in different bands of the spectrum exposing the image sensor. A dual aperture allows a simple mobile phone camera with a typical f-number of 7 (e.g. focal length f of 7 mm and a diameter of 1 mm) to improve its DOF via a second aperture with a f-number varying e.g. between 14 for a diameter of 0.5 mm up to 70 or more for diameters equal to or less than 0.2 mm, wherein the f-number is defined by the ratio of the focal length f and the effective diameter of the aperture. Preferable implementations include optical systems comprising an f-number for the visible radiation of approximately 2 to 4 for increasing the sharpness of near objects in combination with an f-number for the infrared aperture of approximately 16 to 22 for increasing the sharpness of distance objects.

The aperture system may comprise a transparent substrate with two different thin-film filters: a first circular thin-film filter in the center of the substrate forming a first aperture transmitting radiation in a first band of the spectrum and a second thin-film filter formed (e.g. in a concentric ring) around the first filter transmitting radiation in a second band of the spectrum. The first filter may be configured to transmit both visible and infrared radiation and the second filter may be configured to reflect infrared radiation and to transmit visible radiation. The outer diameter of the outer concentric ring may be defined by an opening in an opaque aperture holder or, alternatively, by the opening defined in an opaque thin film layer deposited on the substrate which both blocks infra-read and visible radiation.

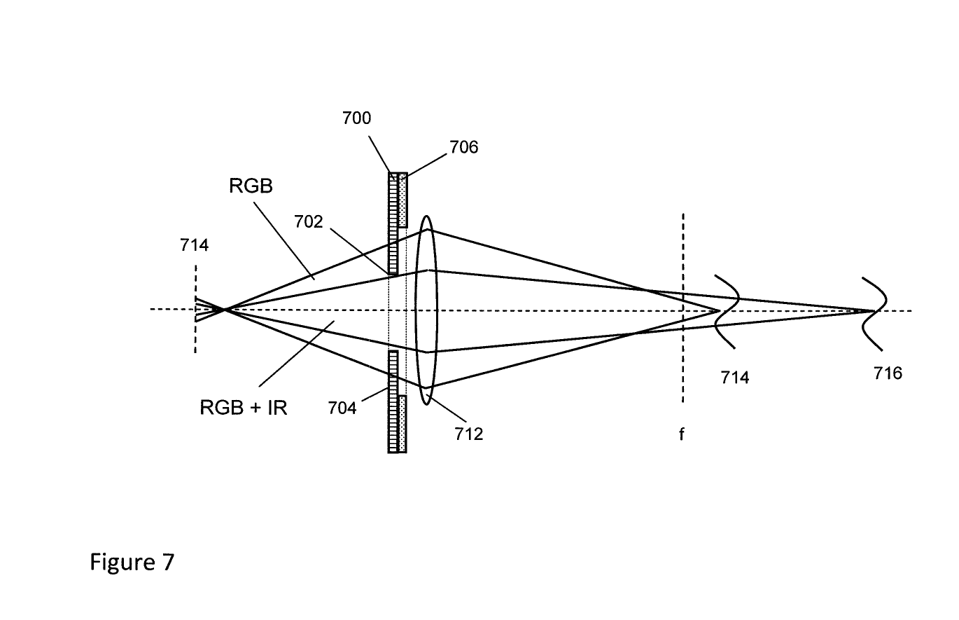

The dual aperture system as depicted in FIG. 6 may be used to improve the DOF of the imaging system. The principle of improving the DOF is schematically depicted in FIG. 7. Visible and infrared spectral energy enters the imaging system via the dual aperture system comprising a filter-coated transparent substrate 700 with a circular hole 702 of a predetermined diameter. The filter coating 704 may transmit visible radiation and reflect infrared radiation. An opaque covering 706 may comprise a circular opening with a diameter, which is larger than the diameter of the hole 702. The cover may comprise a thin film coating which reflects both infrared and visible radiation or may be part of a holder for holding and positioning the substrate 700 in the optical system. Visible and infrared spectral energy passes the aperture system and is subsequently projected by the lens 712 onto the imaging plane 714 of an image sensor, comprising pixels for obtaining image data associated with the visible spectral energy and pixels for obtaining image data associated with the non-visible (infrared) spectral energy, such as an ICFA color image array or an image sensor comprising stacked RGBI photo-sites. The pixels of the image sensor may thus receive a first (relatively) wide-aperture image signal 716 associated with visible spectral energy with having a limited DOF overlaying a second small-aperture image signal 718 associated with the infrared spectral energy having a large DOF. Hence, objects 714 close to the plane of focus f of the lens are projected onto the image plane with relatively small defocus blur by the visible radiation, while objects 716 further located from the plane of focus are projected onto the image plane with relatively small defocus blur by the infrared radiation.

Upon exposure, the image sensor captures both visible and infrared image signals simultaneously in one image frame. If an ICFA color image sensor is used, the DSP may separate the color and infrared pixel signals in the captured raw mosaic image using e.g. a demosaicking algorithm. (not shown). Thereafter, the (visible) color image data and the (non-visible) infrared image data may subjected to a noise reduction method as described with reference to FIG. 5, thereby producing a color image with improved DOF and SNR. It is submitted that the skilled person may easily extend the principle illustrated in FIG. 7 to a multi-aperture system which may be configured to project objects at various distances from the focus plane with a small defocus blur onto the image plane of the image sensor.

When using an imaging system comprising a dual aperture as describe with reference FIGS. 6 and 7, infrared radiation received by the image sensor is mainly transmitted by the red and infrared pixel filters. Hence, the red color component of the captured image frame comprises both a high-amplitude visible red signal and sharp, low-amplitude non-visible infrared signal. Typically, the infrared component will be 8 to 16 times lower than the visible red component. The red balance may be adjusted to compensate for the slight distortion created by the presence of infrared. The sharp, small-aperture infrared image signal may be obtained from the high pass filtered components of the red pixel and the infrared pixel signals. This signal may be used to both increase the DOF and the SNR of the color image.

The infrared image signals produced by the infrared pixels the image sensor may be used to efficiently eliminate the color distortion in the color pixels created by the infrared radiation by subtracting these signals from each color component of the color image signal. Using an image sensor with a RGBI filter array or a stacked RGBI image sensor in combination with a multi-apertures system thus allows the generation of a color image with improved DOF and SNR and color balance.

In a further embodiment, the dual aperture imaging system as describes with reference to FIGS. 6 and 7 may also use a color image sensor comprising color pixels and transparent or panchromatic pixels. As the small-aperture infrared signal is a relatively low-amplitude signal compared to the large-aperture color signal, the infrared contribution in the color pixel signals will be relatively small. In order to remove the dominant color component in the image data produced by the transparent pixels, the color image data produced by the color pixels may used. Subtracting the color image data from the image data produced by the transparent pixels will provide infrared image data which are suitable for use in the noise reduction method as described with reference to FIG. 5.

Further, as the relatively small size of the infrared aperture produces a relatively small infrared image signal, the filtered high-frequency components may be amplified in proportion to the ratio of the visible light aperture relative to the infrared aperture.

Combining a dual aperture as described with reference to FIGS. 6 and 7 with the noise reduction scheme as described with reference to FIG. 5 provides an imaging system with a fixed focus lens (e.g. a camera in a mobile phone) to have a wide aperture, hence effectively operating in lower light situations, while at the same time to have a greater DOF and SNR resulting in sharper pictures.

It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. Method of providing a low noise color image, the method comprising:
exposing an image sensor to visible spectral energy and non-visible spectral energy, said image sensor comprising pixels for obtaining first image data associated with said visible spectral energy and pixels for obtaining second image data associated with said non-visible spectral energy;
generating first and second image data;
subjecting said first image data to a low-pass filter and said second image data to a high-pass filter;
forming a color image by adding at least part of the high frequency components of said second image data to at least part of the low frequency components of said first image data.

2. Method according to claim 1, wherein said pixels for obtaining said first image data comprise one or more color pixel filters configured for transmitting at least part of said visible spectral energy.

3. Method according to claim 1, wherein said pixels for obtaining said second image data comprise one or more infrared transmissive pixels filters configured for transmitting a substantial part of said non-visible spectral energy and blocking a substantial part of said visible spectral energy.

4. Method according to claim 1, wherein said pixels for obtaining first and second image data comprise two or more vertically stacked photo-sensors, at least one of said photo-sensors being responsive to a predetermined part of said visible spectral energy and at least one of said photo-sensor being responsive to a predetermined part of said non-visible spectrum.

5. Method according to claim 1, wherein said image sensor is exposed to said visible spectral energy using at least a first aperture and to said non-visible spectral energy using at least a second aperture.

6. Method according to claim 5, wherein said first aperture is configured to control exposure of said image sensor to at least part of said non-visible spectral energy and wherein said second aperture is configured to control exposure of said image sensor to at least part of said visible spectral energy.

7. Method according to claim 5, wherein said method further comprises amplifying the filtered high-frequency components of said second image data in proportion to the ratio of the first aperture relative to the second aperture.

8. Method according to claim 1, said method further comprising amplifying one or more image sensor signals associated with said visible spectral energy according to at least a first ISO speed and amplifying one or more image sensor signals associated with said non-visible spectral energy according to at least a second ISO speed, wherein said first ISO speed is larger than said second ISO speed,

9. Method according to claim 1, said method further comprising setting the exposure time for exposing one or more pixels associated with said non-visible spectral energy to a lower value than the exposure time for exposing one or more pixels associated with said visible spectral energy.

10. Method according to claim 1, said method further comprising:
providing mosaic image data generated by said image sensor,
generating on the basis of said image data at least one or more first color image data associated one or more color pixels and second image data associated with said infrared pixels using a demosaicing algorithm.

11. Image processing apparatus, comprising:
an input for receiving image data generated by exposing an image sensor to visible and non-visible spectral energy, said image data comprising first image data associated with visible spectral energy and second image data associated with non-visible spectral energy;
a noise reduction unit configured to subject said first image data to a low-pass filter and said second image data to a high-pass filter;
a blending unit for adding said high-pass filtered infrared image data to said low-pass filtered color image data.

12. Imaging system, comprising:
an image sensor configured for exposure to visible spectral energy and non-visible spectral energy, said image sensor comprising pixels for obtaining first image data associated with said visible spectral energy and pixels for obtaining second image data associated with said non-visible spectral energy; an aperture system configured to control exposure of the image sensor to the visible and non-visible spectral energy, and,
an image processing apparatus, comprising:
an input for receiving image data generated by exposing the image sensor to visible and non-visible spectral energy, said image data comprising first image data associated with visible spectral energy and second image data associated with non-visible spectral energy;
a noise reduction unit configured to subject said first image data to a low-pass filter and said second image data to a high-pass filter;
a blending unit for adding said high-pass filtered infrared image data to said low-pass filtered color image data.

13. Imaging system according to claim 12, wherein said aperture system comprises at least a first aperture configured to control exposure of the image sensor to at least part of said non-visible spectral energy and at least a second aperture configured to control exposure of said image sensor to at least part of said visible spectral energy.

14. Image sensor for use in an imaging system according to claim 12, the sensor comprising:
a pixel array defining one or more color pixels sensitive to visible spectral energy and one or more infrared pixels sensitive to non-visible spectral energy;
at least one first amplifier associated with at least a part of said color pixels for setting ISO speed associated with said color pixels to a first ISO speed value and a second amplifier associated with at least a part of said infrared pixels for setting the ISO speed associated with said infrared pixels to a second ISO speed value, said first ISO speed value being larger than said second ISO speed value, preferably said first and second amplifier being configured such that the ratio between said first and second ISO speed value may be controlled approximately between 2 and 8.

15. A non-transitory computer-readable storage medium with an executable computer program product stored thereon, wherein the computer program product instructs a computer processor to perform a method comprising:
exposing an image sensor to visible spectral energy and non-visible spectral energy, said image sensor comprising pixels for obtaining first image data associated with said visible spectral energy and pixels for obtaining second image data associated with said non-visible spectral energy;
generating first and second image data;
subjecting said first image data to a low-pass filter and said second image data to a high-pass filter;
forming a color image by adding at least part of the high frequency components of said second image data to at least part of the low frequency components of said first image data.

16. Method according to claim 8, wherein the ratio between said first and second ISO value being approximately between 2 and 8.

17. Method according to claim 14, wherein the pixel array is a two-dimensional pixel array.
